(19) United States
(12) Patent Application Publication
(10) Pub. No.: US 2021/0326914 A1
(43) Pub. Date: Oct. 21, 2021

(54) ONLINE FEEDBACK NETWORK FOR IDENTIFYING AND REWARDING DEMOGRAPHIC PROFILED FEEDBACK SUBMITTERS

(71) Applicants: Laurent Delly, New York, NY (US); Price-Mars Delly, New York, NY (US)

(72) Inventors: Laurent Delly, New York, NY (US); Price-Mars Delly, New York, NY (US)

(21) Appl. No.: 16/854,167

(22) Filed: Apr. 21, 2020

(51) Int. Cl. G06Q 30/02; G06Q 50/00; G06Q 10/06; G06F 3/12

(52) U.S. Cl. CPC G06Q 30/0203; G06Q 30/0282; G06Q 50/01; G06F 3/12; G06Q 10/06395; G06Q 30/0236; G06Q 30/0205; G06Q 30/0217

(57) ABSTRACT

A system for processing survey feedback through an online community format is provided. The system comprises a processor, a memory, and an application stored in the memory that when executed on the processor implements a feedback project comprising surveying a general population of buyers of a product. The system also applies quality controls to survey results to create a project demographic profile of a subset of the buyers as desired feedback providers. The system also limits future survey recipients to those matching the demographic profile of the subset and creates an online community feedback network comprising survey recipients matching the demographic profile. The system also provides customized rewards to the future survey recipients as incentives to provide continuing meaningful feedback about at least the product.

### FIELD OF THE INVENTION

The present disclosure is in the field of conducting customer surveys. More particularly, the present disclosure matches demographic groups of customers with demographic groups specified by vendors to build survey respondent groups that provide valuable feedback and receive incentives and rewards to continue providing feedback.

### BACKGROUND

Commercial feedback processes currently available focus on open-ended surveys filled with general questions that provide limited insight on processes of learning how customers interact with products and services they buy. Such open-ended surveys do not capture the social experience of a survey respondent.

These generalized surveys do not allow for personalized feedback in an online community marketplace format as means to improve a product or service. They do not offer custom rewards and incentives that may encourage the submission of high-quality feedback in either a virtual (online) or live setting. Generalized surveys do not encourage respondents to provide additional feedback in future surveys.

### BRIEF DESCRIPTION OF THE FIGURE

FIG. 1 is a block diagram of a system of feedback through an online community format according to an embodiment of the present disclosure.

FIG. 2 is a flow chart of a method of feedback through an online community format according to an embodiment of the present disclosure.

### DETAILED DESCRIPTION

Systems and methods described herein enable improvement of commercial goods and services by providing a system for generating sustainable feedback through an online community format in exchange for incentives to survey respondents. An online platform of a community feedback marketplace provided herein generates feedback that captures the social experiences of the respondents.

After initially surveying large general populations of buyers, systems employ quality controls to identify subsets of survey respondents that consistently provide meaningful and valuable feedback, as well as respondents whose demographic profiles match the profiles specified by product vendors generating the surveys. Systems provided herein may thereafter direct further and more detailed surveys to respondents in the identified subsets with the objective of receiving even more meaningful feedback. Those respondents, who may be referred to as “feedback submitters”, are encouraged to continue providing deeper and more detailed feedback.

Survey feedback and other data is shared among respondents within groups to create communities of online feedback submitters. Social media is used to link respondents and encourage feedback submitters to communicate with each other and foster collaboration of ideas and suggestions. Vendors whose products and services are the subject of surveying may also be part of the communities and communicate directly with feedback submitters about specific remarks made by submitters.

Using systems and methods provided herein, such vendors launch projects requesting detailed and meaningful feedback. The vendors request the system to create project demographic profiles that may align with demographic profiles of customers who provide desired feedback. The system compares project demographic profiles with demographic profiles of feedback submitters to find matches that yield potentially valuable sources of feedback.

The vendors, who may be referred to as “feedback receivers”, may participate in the communities described above that use social network to communicate and share ideas. The feedback receivers also sponsor the sending of incentives and rewards to feedback providers who consistently generate valuable survey response material to feedback receivers, material the receivers may use in improving their products and services.

When a feedback receiver, for example a vendor of consumer products, receives an item of feedback that the feedback receiver considers favorable, the receiver may print or otherwise copy portions of the feedback to stickers or placards. Such media may then be attached or posted to products or displays in public places that prospective customers may view. The quality control measures provided herein are used in determining the appropriate areas of feedback to use in such postings.

Customized rewards and incentives from feedback receivers comprising at least entrepreneurs, businesses, and organizations are given to feedback submitters in return for the delivery by submitters of personalized feedback. The feedback may be used by feedback receivers toward improving a product or service at various phases of the product or service lifecycle. Feedback receivers hence are given means to identify items of information that may be vital for improvement of the goods and services.

Feedback receivers are also provided means to effectively pinpoint flaws and opportunities through a mutually beneficial, reward-based process. Systems and methods utilize skills, knowledge, and personal experience of feedback submitters as bases for delivering unique and tailored feedback. Such feedback may improve the business value proposition of a service or product offered in the marketplace.

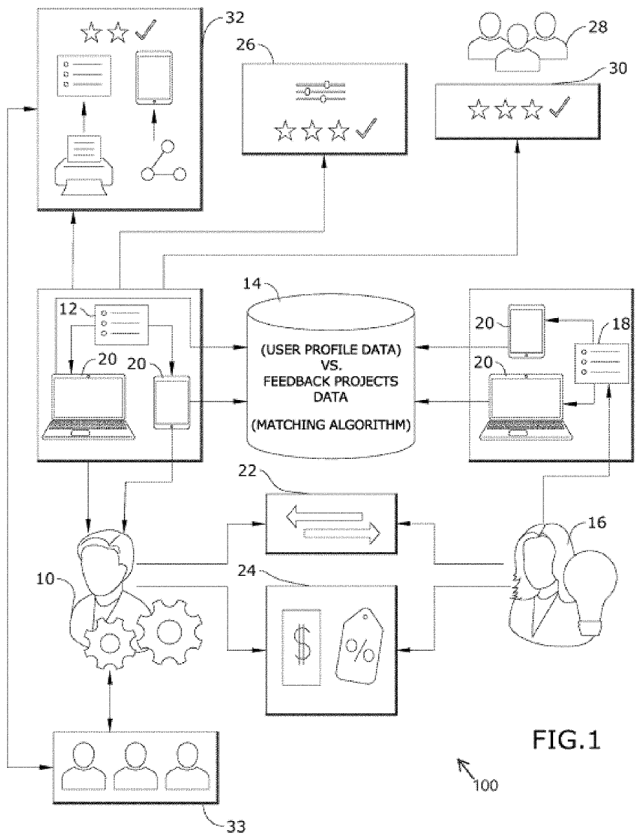

Turning to the figures, FIG. 1 is a block diagram of a feedback system and method through an online community format in accordance with an embodiment of the present disclosure. FIG. 1 depicts components and interactions of a system 100 provided herein.

The components of the system 100 comprise feedback receivers 10, feedback response data 12, an online feedback community network 14, feedback submitters 16, profile information 18, and at least one computer 20. The components also comprise incentives and rewards 24, quality control measures 26, business entities 28, feedback stickers 30, shared feedback 32, and other users 33.

For brevity purposes, the feedback receivers 10, the feedback response data 12, the online feedback community network 14, and the feedback submitters 16 may be referred to hereafter as the receivers 10, the data 12, the network 14, and the submitters 16. While not shown, at least one application may execute on the computer 20 and in the network 14 that provide systems and methods described herein.

The feedback submitters 16, usually customers, and the feedback receivers 10, usually vendors, are connected to the online feedback community network 14. The network 14 may be an Internet-based platform and may execute at least on the computer 20. A matching algorithm may execute on the computer 20 and be adapted to use similarities in data sets including feedback response data 12 and machine intelligence learning.

A feedback submitter 16, based on his/her use of products sold by the feedback receiver 10, submits feedback response data 12 via the network 14. This data 12 may comprise written responses, live voting data, and voice messages.

Incentives and rewards 24 may be released by the feedback receiver 10 once the feedback response data 12 has been approved. Such incentives and rewards 24 may be given to the feedback submitter 16 via online shop, mail, or live and in person, electronically or physically. Feedback response data 12 is exportable to other feedback submitters 16 on the network 14 as shared feedback 32.

Shared feedback 32 is subject to quality control measures 26 that may be adapted to define how, what portion, and to whom the data 12 is exported and shared. The data 12 may be shared with business entities 28 as well as other peers 33 affiliated with the associated feedback receiver 10.

The business entities 28, if registered users of the network 14, may also provide feedback. The other peers 33 may be either offline peers or online, as described by the quality control measures 26. Feedback stickers 30, receipts, or APIs may be used to display or communicate data 12. Analytics provided via a dashboard used by feedback receivers 10 may reveal metrics on how to avoid pitfalls and increase value and customer retention.

Users are given at least three options to enroll or sign-up to submit feedback. A first option allows users to enroll as feedback receivers 10, feedback submitters 16, or both. A second option allows them to specify their role in using he platform and to provide personal information and to enroll using social media APIs embedded in popular social networking platforms. A third option provides for a feedback receiver 10 to create a simple profile, post a basic one-question (or more) feedback project, and locate feedback submitters who are relevant to the feedback project.

The data 12 may be processed using programming code comprising at least one of php, html, and java which may include various algorithms that execute the activities done by both feedback receivers 10 and submitters 16 using a web platform connected to the internet. Feedback data 12 is converted to analytical, textual and numerical formats, which provide visual and statistical indication and remedies (corrective steps and suggestions) for a business (the feedback receiver 10) to improve. With the end data 12, feedback receivers 10 may be able to develop sustainable improvements for their businesses.

Feedback receivers 10 receive actionable feedback data 12 based on the aggregate data from feedback submitters 16 run by internet programming languages which identifies and displays data 12 via the feedback receiver dashboards in order to improve a business. The feedback response data 12 contains the steps and recommendations for improvement. The data 12 may be exported to share and distribute corrective actions to peers and teams of the business practitioner (the feedback receiver 10). Feedback data 12 may be exported on point-of sale receipts or customized as a decal sticker allowing the business to print and display an active feedback project and obtain instant feedback to test new products and services with store, venue, or event guests and customers.

Composite methods are provided herein to collect business feedback faster through a specific reversible process that requires the usage of internet/web programming/code. The reversibility of the process allows not only the business to collect feedback but send feedback as well. The process is a reward-for-feedback reversible loop which can be used in web application and eventually in a future mobile application form as well.

In an example, a regional bus line that operates in an area comprising several states may wish to expand its routes while increasing ridership on its existing routes. Management of the bus line may be considering fare changes or schedule adjustments and want customer input before implementing such changes.

The bus company operator may begin by enrolling in the system using one of the three methods described above. A profile of the operator (the feedback receiver 10 in this example) is created. The operator creates a customized project based on problems the operator has observed with the company's route network, fare structure, or other aspects of its business with which riders have contact.

The operator adds details and instructions for feedback submitters 16, i.e. riders, to consult when responding to surveys. The operator also selects if he/she is seeking public or private feedback and selects one of anonymous or non-anonymous feedback. The operator might also add a video clip of a problem area such as a route map or fare chart and notes when a survey period expires.

The bus company operator, the feedback receiver 10 in this use case, may construct a survey with as many polls, ratings and questions as possible to solicit meaningful feedback from riders. Sample questions might ask, “Would a different fare structure on weekends encourage you to ride with us more often?” or “What cities or towns that are presently not served or underserved would you like to see added to our routes?” The operator might also create customized rewards for various classes of riders.

The bus company operator may create a demographic profile that targets specific feedback submitters 16 and may add in experience-based requirements for feedback submitters 16 and enter in promotional codes for those submitters 16 to receive incentives. Once the project is posted, the operator is presented with a feedback submitter screen which allows the operator to search for feedback submitters based on one or more options. Such options include industry, occupation, location, skills, interests, username, gender, age range, and proximity to bus depots or cities served by the bus company. Feedback submitters 16 can also be located and specifically chosen by the bus company operator via a feedback submitter map provided herein.

Once a feedback submitter 16 is located, a feedback submitter information card will display a match percentage. If the feedback submitter 16 described in the card meets requirements set by the bus company operator and the details of the project, the submitter 16 is sent an invitation to respond and submit feedback. After the submitter views the invitation that may be received via email, the submitter 16 may begin submitting feedback on the project.

While the project is ongoing, the bus company operator may receive various surveys submitted by invited and non-invited feedback submitters 16. The operator may extend the project past the expiration date initially set. The operator may print feedback stickers 30 to notify riders of an online feedback project and offer incentives for riders to go online or on the phone to join in and receive incentives such as discounts on future trips or a chance to win free trips.

The operator may use a live-feedback option as a tool to solicit live feedback, votes and other insight during events held in cities served by the bus line. The feedback received by the operator may be text, recorded voice, and even video. The feedback may be analytical, graphical, and/or numeric.

The operator may, as a feedback receiver 10 and project creator, be allowed to joint online networks to which some of the bus line's riders may belong. The operator may share some feedback with riders on the network in an effort to encourage further feedback from riders. The operator would of course protect the confidentiality of feedback receivers 16 whose feedback the operator shares on the network.

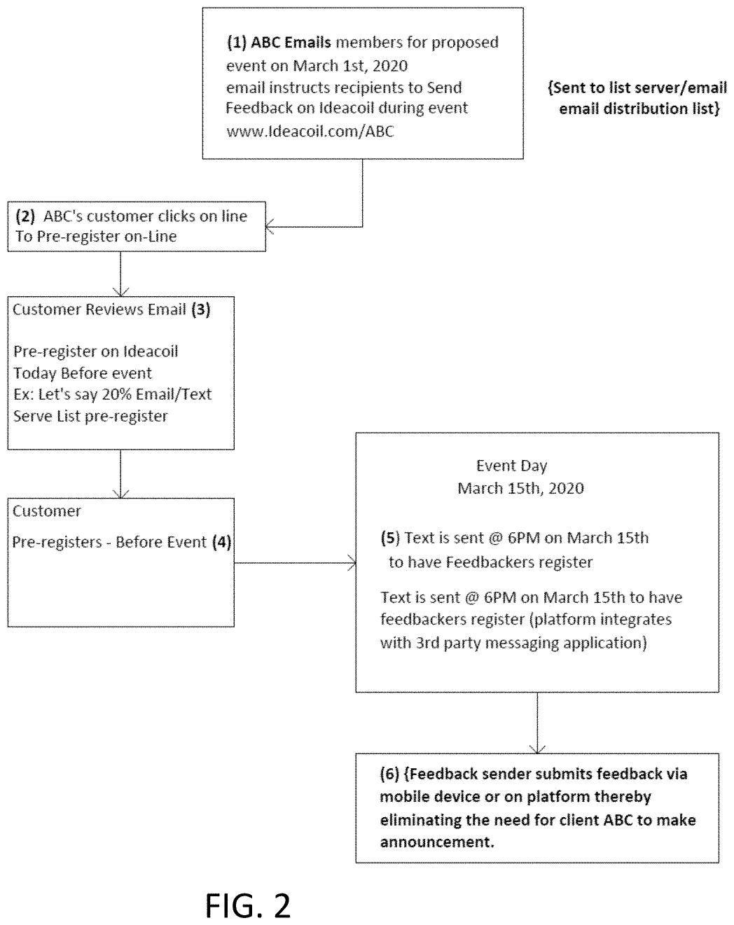

FIG. 2 is a flow chart of a method of feedback through an online community format according to an embodiment of the present disclosure. FIG. 2 illustrates a process flow of pre-registration for feedback submitters. The purpose of pre-registration is to allow feedback submitters to pre-register before attending an event. In the scenario depicted in FIG. 2, a client is ABC and is the business sending feedback from its customers (members) during a proposed event.

Beginning at (1), ABC emails members for a proposed event on Mar. 1, 2020. The email instructs recipients to send feedback on Ideacoil during the event. The emails are sen4 to list server/email distribution list. At (2), ABC's customer clicks online to pre-register and at (3) the customer reviews the email. At (4), the customer pre-registers. At (5), at text message is sent on event day, Mar. 15, 2020, to have feedbackers register. At (6), the feedback sender submits feedback via mobile device or on platform thereby eliminating the need for client ABC to make an announcement.

What is claimed is:

1. A system for processing survey feedback through an online community format, comprising:
a processor;
a memory; and
an application stored in the memory that when executed on the processor:
implements a feedback project comprising surveying a general population of buyers of a product,
applies quality controls to survey results to create a project demographic profile of a subset of the buyers as desired feedback providers,
limits future survey recipients to those matching the demographic profile of the subset,
creates an online community feedback network comprising survey recipients matching the demographic profile, and
provides customized rewards to the future survey recipients as incentives to provide continuing meaningful feedback about at least the product.

2. The system of claim 1, wherein the quality controls comprise at least discarding survey results of minimal value and disqualifying providers of such surveys.

3. The system of claim 1, wherein the quality controls are adapted to define how, what portion, and to whom feedback response data is exported and shared.

4. The system of claim 1, wherein the system screens the survey feedback based on direct customer experience.

5. The system of claim 1, wherein the survey feedback is gathered by at least one of virtual and live setting.

6. The system of claim 1, wherein the system prints selected feedback for printing on media provided with products.

7. The system of claim 1, wherein the system provides challenges in social format comprising at least one of video, audio, images, and social media.

8. A system for processing survey feedback, comprising:
a processor;
a memory; and
an application stored in the memory that when executed on the processor:
creates a demographic profile of feedback providers for a feedback project associated with at least one product,
builds, based on quality control analysis of previous survey results and historical sales data, a database of customer matching the demographic profile,
provides incentives to customers in the database to return continuing substantive survey feedback, and
creates an online community platform to receive and disseminate survey feedback.

9. The system of claim 8, wherein surveys are directed to learning how customers interact with the at least one product.

10. The system of claim 8. wherein the surveys are directed to inducing customers to recommend improvements to the at least one product.

11. The system of claim 8, wherein the feedback is received on a live-streamed basis.

12. The system of claim 8, wherein incentives are provided for redemption online shopping, telephone, mail, and live shopping at retail locations.

13. The system of claim 8, wherein the system provides a dashboard displaying metrics on how to avoid pitfalls and increase value and customer retention.

14. The system of claim 8, wherein the quality control analysis of previous survey results and sales data comprises at least discarding survey results deemed to be of minimal value and disqualifying respondents from participation in future surveys.

15. The system of claim 8, wherein survey respondents take action to enroll in survey programs adminstered by the system.

15. A method for processing survey feedback through an online community format, comprising:
a computer receiving feedback through an online community, the feedback related to at least one product;
the computer applying quality control measures to the received feedback to extract content meeting requirements for overall quality;
the computer customizing rewards and incentives designed to elicit continuing survey feedback meeting the requirements; and
the computer delivering the rewards and incentives to feedback providers identified as consistently providing feedback meeting the requirements.

16. The method of claim 15, further comprising the computer creating feedback groups comprising feedback providers meeting specific demographic guidelines.

17. The method of claim 15, further comprising the computer qualifying the feedback providers through identification of skills, knowledge, and personal experience metrics of the feedback providers.

18. The method of claim 15, wherein information used to create feedback groups comprises occupation, location, skills, interests, gender, and age group.

19. The method of claim 15, wherein the survey feedback is gathered by at least one of virtual and live setting.

20. The method of claim 15, wherein the computer prints selected feedback for placement on media provided with products.
